(19) United States
(12) Patent Application Publication
(10) Pub. No.: US 2012/0041765 A1
(43) Pub. Date: Feb. 16, 2012

(54) ELECTRONIC BOOK READER AND TEXT TO SPEECH CONVERTING METHOD

(75) Inventors: CHIA-HUNG CHIEN, Tu-Cheng (TW); TUN-TAO TSAI, Tu-Cheng (TW); CHUN-WEN WANG, Tu-Cheng (TW); LIANG-MAO HUNG, Tu-Cheng (TW)

(73) Assignee: HON HAI PRECISION INDUSTRY CO., LTD., Tu-Cheng (TW)

(21) Appl. No.: 13/104,957

(22) Filed: May 10, 2011

(30) Foreign Application Priority Data
Aug. 10, 2010 (CN) 201010249944.4

(51) Int. Cl. G10L 13/08

(52) U.S. Cl. 704/260; 704/E13.001

(57) ABSTRACT

An electronic book reader includes a text obtaining module, a text analysis module, a speech synthesis module, a control module, and an audio output device. The text obtaining module is used for obtaining a selected segment of a text. The text analysis module is used for analyzing a time phrase of the selected segment to obtain a waiting time period according to meaning of the time phrase in the selected segment. The speech synthesis module is used for converting the selected segment into speech. The control module is used for sending the content of the selected segment to the speech synthesis module. Wherein the control module waits for the waiting time period after sending the time phrase to the speech synthesis. The audio output module is used for playing the speech.

### BACKGROUND

1. Technical Field

The present disclosure relates to electronic book readers, and particularly to, an electronic book reader and a text to speech converting method.

2. Description of Related Art

An electronic book (e-book) is a text file providing the digital media equivalent of a conventional printed book. E-books are usually read on personal computers or smart phones, or on dedicated hardware devices known as e-book readers.

An e-book reader usually has a player to play the texts of the e-books. Some users may use e-book reader to play a text based instructions, such as cooking, so a user can cook according to the text played by the e-book reader. However, users might not be able to follow the text to cook with due to it not being synchronized with the audio.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of the electronic book reader in accordance with an embodiment.

FIG. 2 is a flow chart of a text to speech converting method of the electronic book reader of FIG. 1 in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

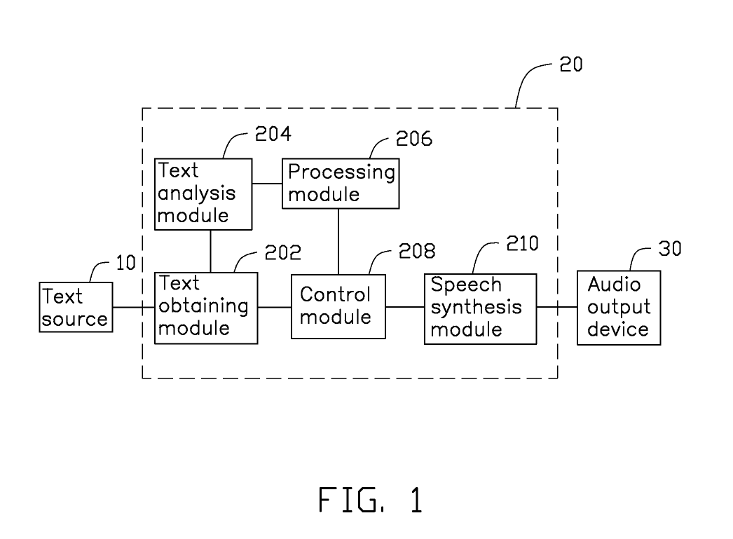

Referring to FIG. 1, an electronic book reader 20 is connected to a text source 10, and an audio output device 30.

The electronic book reader 20 includes a text obtaining module 202, a text analysis module 204, a processing module 206, a control module 208, and a speech synthesis module 210. The text obtaining module 202 is connected to the text analysis module 204 and the control module 208. The text analysis module 204 is connected to the processing module 206. The processing module is connected to the control module 208. The control module 208 is connected to the speech synthesis module 210.

The text source 10 is stores a plurality of texts. The audio output device 30 is used for outputting audio signals. In one embodiment, the audio output device 30 is a loudspeaker or an earphone. The text obtaining module 202 is used for obtaining a selected text from the text source 10. The text analysis module 204 is used for analyzing a time phrase of the selected segment according to a plurality of dictionaries stored in the text analysis module 204, and obtaining a waiting time period according to meaning of the time phrase in the selected segment. For example, words “2 minutes” in “frying it for 2 minutes in boiling oil” is a time phrase and the waiting time period corresponds to the time phrase is 2 minutes.

The processing module 206 is used for creating a control script according to the control content. The control script file includes a reading part and a waiting part according to the waiting time period. The processing module 206 includes a configuration file. The control script file is stored in the configuration file. The configuration file is related to the selected segment. The electronic book reader 20 uses the configuration file when reading the selected segment again. The configuration file is INI file, XML file or other file.

The control module 208 is used for sending the selected segment according to the control script file. The speech synthesis module 210 is used for converting the selected segment to speech and send the speech to the audio output device 30.

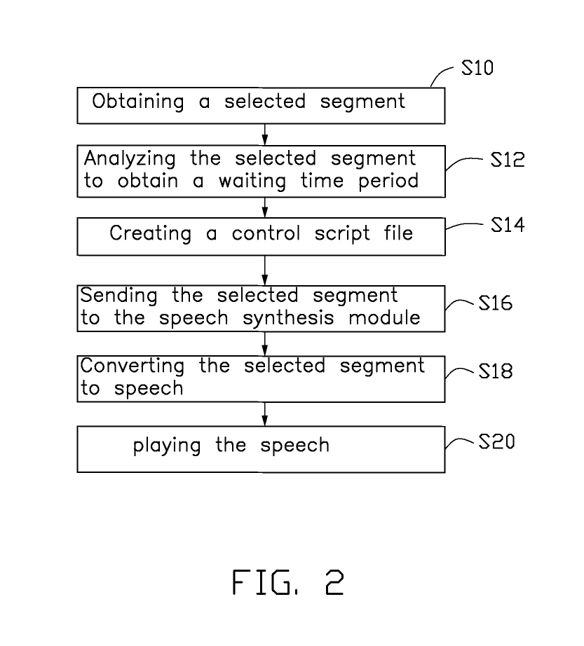

Referring to FIG. 2, a text to speech converting method on the electronic book reader is shown. An embodiment of the method is as follows.

In step S10, the text obtaining module 202 obtains a selected segment of selected text from the text source 10.

In step S12, the text analysis module 204 analyzes a time phrase of the selected segment to obtain a waiting time period according to a meaning of the time phrase in the selected segment.

In step S14, the processing module 206 creates a control script according to the waiting time period.

In step S16, the control module 208 sends the selected segment to the speech synthesis module 210 sequentially, wherein the control module 208 waits for the waiting time period after sending the time phrase to the speech synthesis module 210.

In step S18, the speech synthesis module 210 converts the selected segment to speech and sends the speech to the audio output device 30.

In step S20, the audio output device 30 outputs the speech.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. An electronic book reader, comprising:
a text obtaining module, the text obtaining module is adapted to obtain a selected segment of a text;
a text analysis module, the text analysis module is adapted to analyze a time phrase of the selected segment to obtain a waiting time period according to meaning of the time phrase in the selected segment;
a speech synthesis module, the speech synthesis module is configured to convert the selected segment into speech;
a control module, the control module configured to send the selected segment to the speech synthesis module, wherein the control module is adapted to wait for the waiting time period after sending the time phrase to the speech synthesis module; and
an audio output device, the audio output device adapted to play the speech.

2. The electronic book reader of claim 1, wherein the text analysis module comprises a plurality of dictionaries for analyzing the meaning of the time phrase in the selected segment.

3. The electronic book reader of claim 1, further comprising a processing module, wherein the processing module is adapted to create a control script file according to the waiting time period, and the control module is adapted to send the selected segment to the speech synthesis module according to the control script file.

4. The electronic book reader of claim 3, wherein the control script file corresponds to the selected segment.

5. A text to speech converting method, applied in an electronic book reader, the text to speech converting method comprising:
obtaining a selected segment of a text;
analyzing a time phrase of the selected segment to obtain a waiting time period according to meaning of the time phrase in the selected segment;
converting the selected segment into speech sequentially, and waiting for the waiting time period after the time phrase is converted; and
playing the speech.

6. The text to speech converting method of claim 5, further comprising creating a control script file according to the waiting time period, and converting the selected segment into the speech according to the control script file.

7. The text to speech converting method of claim 6, wherein the control script file corresponds to the selected segment.

8. A text to speech converting method, applied in an electronic book reader, the text to speech converting method comprising:
providing a text obtaining module, the text obtaining module adapted to obtain a selected segment of a text;
a text analysis module, the text analysis module adapted to analyze a time phrase of the selected segment to obtain a waiting time period according to meaning of the time phrase in the selected segment;
a speech synthesis module, the speech synthesis module adapted to convert the selected segment into speech;
a control module, the control module adapted to send the selected segment to the speech synthesis module, wherein the control module waits for the waiting time period after sending the time phrase to the speech synthesis module; and
an audio output device, the audio output device adapted to play the speech;
the text obtaining module obtaining the selected segment;
the text analysis module analyzing the time phrase of the selected segment to obtain the waiting time period according to the meaning of the time phrase in the selected segment;
the speech synthesis module converting the selected segment into the speech, and waiting for the waiting time period after the time phrase is converted; and
the audio output device playing the speech.
